(19) United States
(12) Patent Application Publication
(10) Pub. No.: US 2008/0055112 A1
(43) Pub. Date: Mar. 6, 2008

(54) WATER DETECTION UNIT AND SYSTEM

(76) Inventors: Joseph Ralph McGinty, Madison, AL (US); Derek Phelps Gardner, Huntsville, AL (US); Gene Phelps Gardner, Huntsville, AL (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/685,910

(22) Filed: Mar. 14, 2007

Related U.S. Application Data
(60) Provisional application No. 60/824,177, filed on Aug. 31, 2006.

(51) Int. Cl. G08B 21/00

(52) U.S. Cl. 340/870.16

(57) ABSTRACT

A leak detector apparatus and system for use with a plumbing fixture, appliance or other potential water leak source. The leak detector apparatus includes an electrically non-conducting mat that is shaped and dimensioned to rest on the floor. The mat comprises multiple layers of non-conducting closed cell foam and has a plurality of water collector cups formed therein. Spaced-apart sensor wires are provided and form a peripheral sensor that extends between the multiple layers of the mat body and the sensor wires generally extend through the water collector cups. The sensor wires are operative to sense the presence of water in the cups. An electronics module is provided and is associated with the sensor wires and electrically coupled to the sensor wires for triggering an alert in response to the presence of water in one or more of the cups.

### CROSS-REFERENCE TO RELATED APPLICATIONS

The benefit of the filing date of U.S. provisional patent application Ser. No. 60/824,177, filed Aug. 31, 2006, entitled WATER DETECTION UNIT AND SYSTEM, is hereby claimed, and the specification thereof is incorporated herein by this reference.

### TECHNICAL FIELD

The present invention relates generally to a water sensing system and in particular relates to a water detection system for sensing water leaks around plumbing fixtures and various appliances.

### BACKGROUND OF THE INVENTION

Every year, considerable damage is done to homes and business establishments by leaking water from roof leaks, plumbing fixtures, pipes, water heaters, air conditioners, and other appliances. These leaks often occur for a long period of time before any evidence or damage is noticed, often with catastrophic results, such as floors falling in or excessive mildew and/or mold growth. This damage often results in insurance claims and settlements that cost businesses, consumers and insurance companies untold millions of dollars per year. Although there are some leak detection systems in the market, most are expensive, complicated, and/or difficult for the user to install.

A water leak often develops at night, on weekends, or at other times when the leak is not easily detected. Also, water leaks can occur in second homes (in which the owner might not be present for months at a time). Additionally, water leaks often occur in locations that are not readily accessible by a worker or homeowner, or in locations that are not often visited. Therefore, water leaks are often not detected until the leak has become a substantial problem, which may result it flooding, floors or walls caving in, severe wood rot, etc. These problems and others can be incredibly expensive and time consuming to repair.

Accordingly, it can be seen that a need yet remains in the art for a leak detection apparatus and leak detector system that is easily installed, alerts a user to the presence of a water leak, and is reliable in operation. It is to the provision of such a leak detection apparatus and leak detection system that the present invention is primarily directed.

### SUMMARY OF THE INVENTION

Briefly described, in a first preferred form the present invention comprises a leak detector for use on a floor and in conjunction with an appliance, plumbing fixture or other potential water leak source. The leak detector apparatus includes a non-conducting mat shaped and dimensioned to rest on the floor and to be positioned under, beside, or around the appliance, plumbing fixture or other potential water leak source. The mat includes one or more layers and has a plurality of water collector cups formed therein. The leak detector also includes a pair of spaced apart sensor wires extending within or beneath one of the one or more layers of the mat and extending through the water collector cups. The sensor wires are operative to sense the presence of water in the cups. An electronics module is associated with the sensor wires and electrically coupled thereto for triggering an alert in response to the presence of water in one or more of the cups.

Preferably, the mat is shaped to generally match a footprint of the appliance, plumbing fixture or other potential water leak source. Also, it is preferred that the pair of spaced apart sensor wires extends generally around the periphery of the mat.

Preferably, the leak detector apparatus has a second pair of spaced apart sensor wires, with one pair of the sensor wires provided for detecting water falling onto the leak detector apparatus and the other pair of sensor wires provided for detecting water seeping under the mat.

Optionally, the electronics module is coupled to a master controller via RF, IR or some other non-contact manner. Alternatively, the electronics module can be electrically coupled to a master controller using conventional wires. The electronics module can be positioned on the mat or off the mat, as dictated by space requirements.

In some specific example embodiments of the present invention, the leak detector is specially adapted for use with particular appliances or plumbing fixtures. For example, for use with a refrigerator the mat can comprises an elongated, narrow mat to be positioned along the rear edge of a refrigerator (to detect water leaks at the connection of a water supply line to the back of the refrigerator). To detect leaks at a toilet the mat preferably comprises a generally U-shaped mat. Further, the mat can be a generally rectangular mat having spaced apart cut-outs and being adapted for use with a variety of devices, such as a dishwasher, ice maker, or washing machine, the cut-outs accommodating feet of the dishwasher, ice maker or washing machine therein.

Optionally, the mat can include shallow funnels for collecting water and funneling it into the cups. Also, the spaced-apart sensor wires can be spaced apart horizontally and/or vertically. The mat can be made in multiple layers and the layers can be used to separate the spaced-apart wires. Preferably, the sensor wires are un-insulated prior to installation between the multiple layers of the mat.

The mat can be provided with dimples formed in the lowermost layer thereof to deepen the water collector cups and can have feet formed in the lowermost layer thereof to support most of the mat above the floor to minimize the growth of mold, algae, mildew, and fungus.

In another form the present invention comprises a leak detector apparatus for use on a floor and in conjunction with an appliance, plumbing fixture or other potential water leak source. The leak detector apparatus includes a non-conducting mat shaped and dimensioned to rest atop the floor and to be positioned under, beside, or around the appliance, plumbing fixture or other potential water leak source. The leak detector apparatus also includes a pair of spaced apart sensor wires extending within or beneath the mat and extending generally along at least one peripheral edge thereof, the sensor wires being operative to sense the presence of water along a peripheral edge of the appliance, plumbing fixture or other potential water leak source. Further, an electronics module is associated with the sensor wires and electrically coupled thereto for triggering an alert in response to the presence of water.

Preferably, the mat is shaped to generally match a footprint of the appliance, plumbing fixture or other potential water leak source. Optionally, the apparatus includes a second pair of spaced apart sensor wires, with one pair of the sensor wires provided for detecting water falling onto the leak detector apparatus and the other pair of sensor wires provided for detecting water seeping under the mat.

The mat can comprises an elongated, narrow mat for use with a refrigerator, a generally U-shaped mat for use with a toilet, or other device-specific shapes. For example, the mat can be a generally rectangular mat having spaced apart cut-outs and being adapted for use with a dishwasher, ice maker, or washing machine, the cut-outs accommodating feet of the dishwasher, ice maker or washing machine therein.

In another form, the present invention is a leak detector system for use on a floor and in conjunction with two or more appliances, plumbing fixtures or other potential water leak sources. The system includes a plurality of leak detection mats adapted to be placed on the floor positioned under, beside, or around an appliance, plumbing fixture or other potential water leak source, with each leak detection mat including one or more sensors for detecting the presence of liquid. A plurality of local processors are electrically coupled to the plurality of sensors, with the local processors being provided at least one per leak detection mat. A master controller is in communication with the local processors for monitoring the function and operation of each local processor.

Other features and advantages of the invention will become evident from reading the following description of the invention in conjunction with the accompanying drawings.

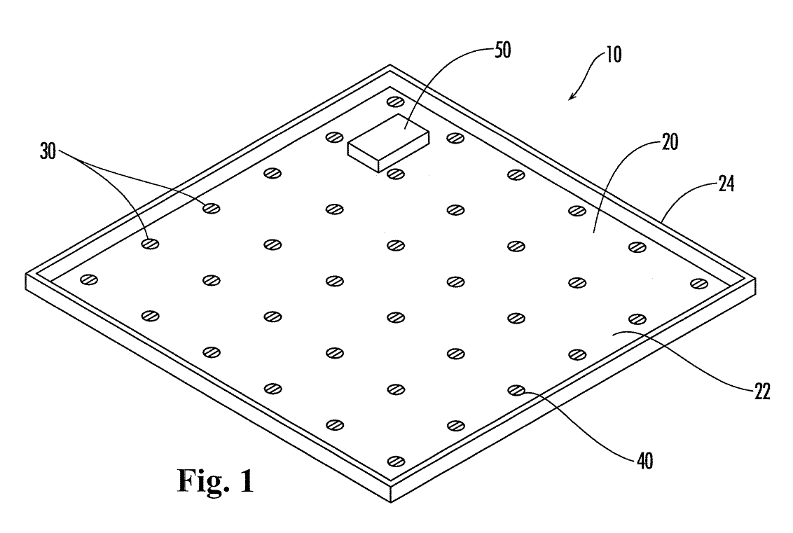

FIG. 1 is a perspective view of a leak detector apparatus according to an example embodiment of the present invention.

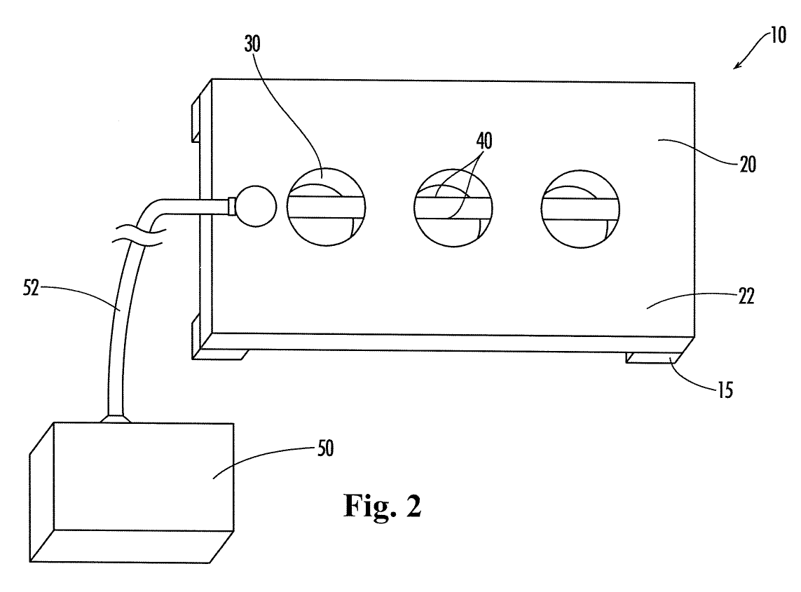

FIG. 2 is a top perspective view of a leak detector apparatus according to a second example embodiment of the present invention.

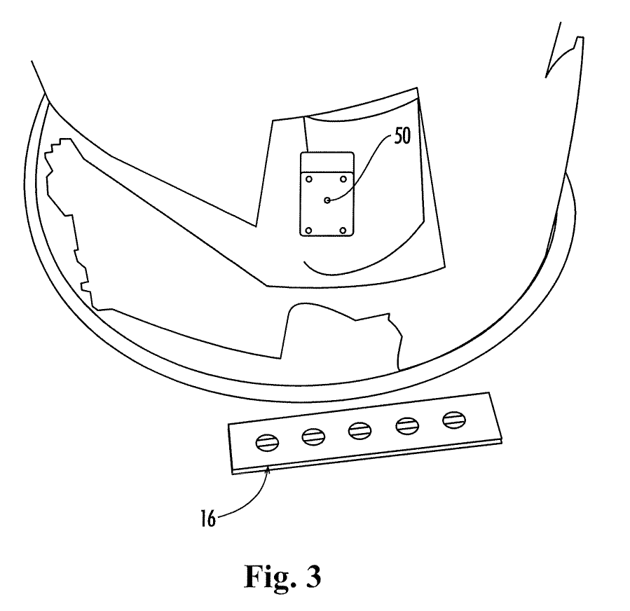

FIG. 3 is a perspective view of a leak detector apparatus of the type shown in FIG. 2 having an electronics module mounted to an appliance.

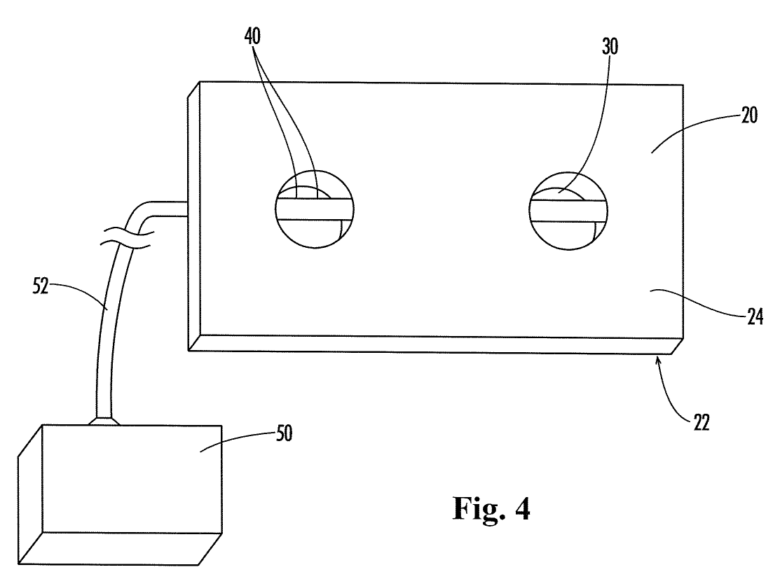

FIG. 4 is a bottom perspective view of the leak detector apparatus shown in FIG. 2.

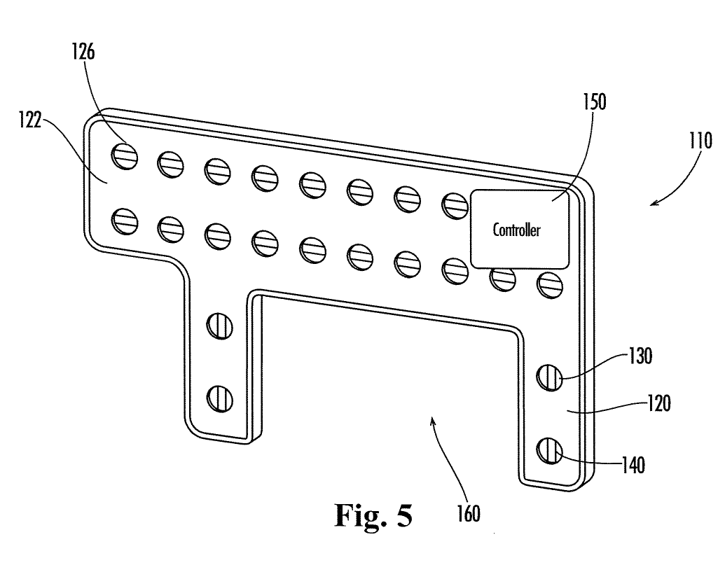

FIG. 5 is a perspective view of a leak detector apparatus according to a third exemplary embodiment of the present invention.

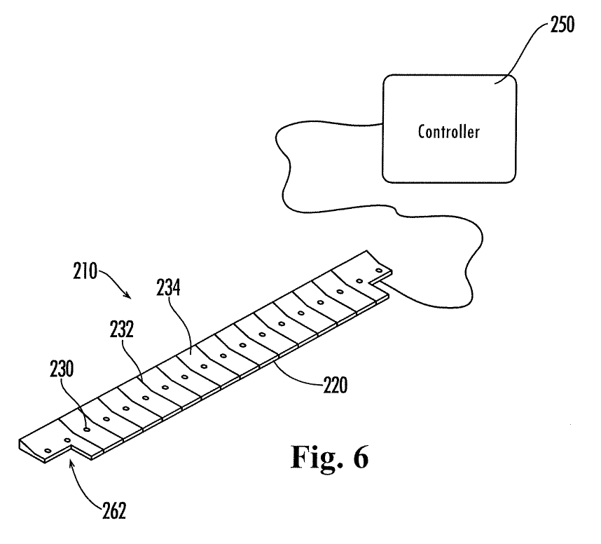

FIG. 6 is a perspective view of a leak detector apparatus according to a fourth exemplary embodiment of the present invention.

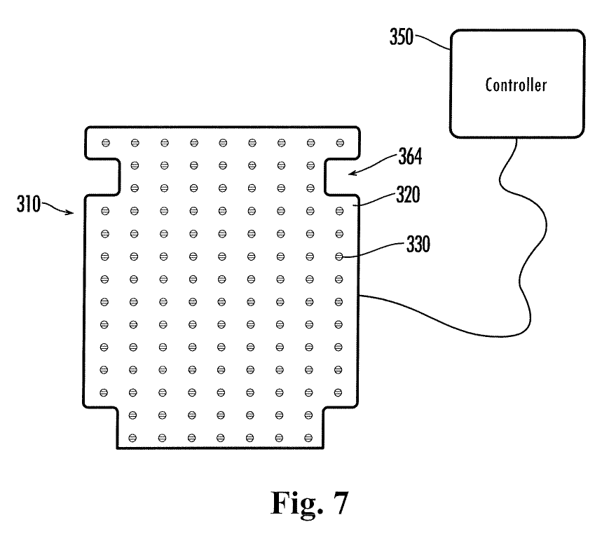

FIG. 7 is a perspective view of a leak detector apparatus according to a fifth exemplary embodiment of the present invention.

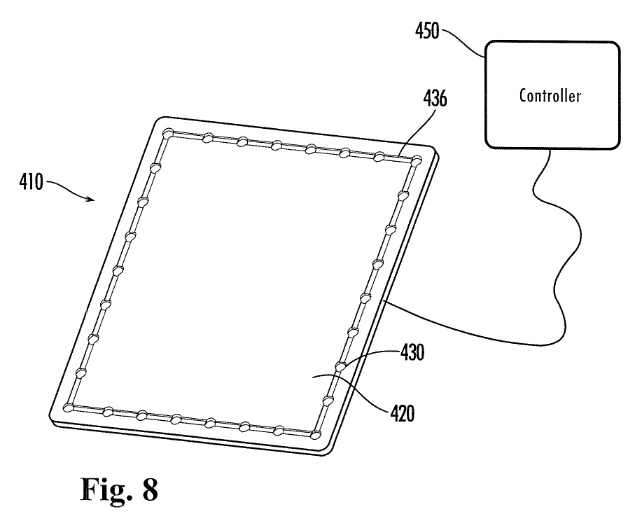

FIG. 8 is a perspective view of a leak detector apparatus according to a sixth exemplary embodiment of the present invention.

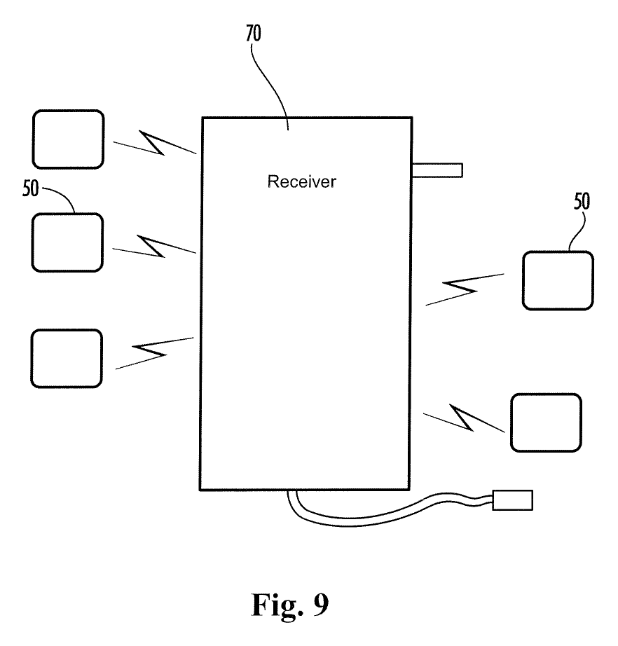

FIG. 9 is a functional diagram of a leak detection system according to an example embodiment of the present invention.

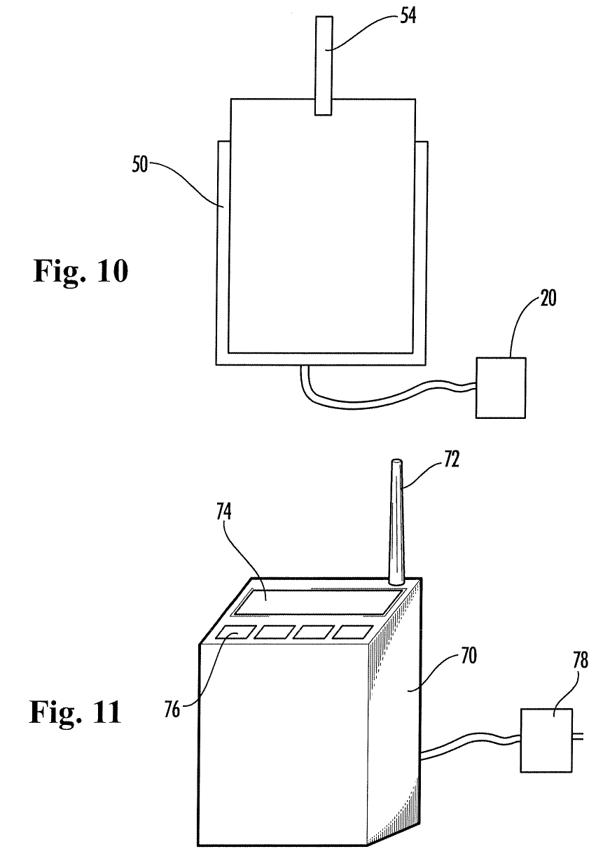

FIG. 10 is a side view of the electronics module shown in FIG. 9.

FIG. 11 is a perspective view of the master controller shown in FIG. 9.

### DETAILED DESCRIPTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

With reference now to the drawing figures, in which like numerals represent like elements or steps throughout the several views, FIG. 1 depicts a leak detector apparatus 10 according to an example embodiment of the present invention. The leak detector apparatus 10 of the present invention can be used in conjunction with an appliance, plumbing fixture, or other potential water leak source to detect and alert a user to the presence of a water leak. Generally, the leak detector apparatus 10 comprises a non-conducting mat 20, the mat having a plurality of water collection cups 30 and at least one pair of sensor wires 40. An electronic module 50 is associated with the sensor wires. The leak detector apparatus 10 can be formed into a variety of shapes and sizes to accommodate all types of appliances and/or can be modified for use with a variety of plumbing fixtures. For example, the leak detector apparatus 10 can be shaped to generally match the footprint of the appliance, plumbing fixture, or other potential leak source.

In example embodiments, the leak detector apparatus 10 is comprised of a non-conducting mat 20 that is preferably constructed of one or more layers of closed-cell foam, rubber, and/or plastic, however, other appropriate non-conducting, non-absorbing materials can be used. Additionally, it is preferable the mat 20 be flexible to aid in positioning the mat in a desired location. The mat 20 can be placed beneath and/or adjacent to an appliance or other plumbing fixture. The mat 20 includes at least one water collection cup 30, and preferably a plurality of water collection cups, formed therewithin for trapping and collecting any water that may have leaked from the adjacent appliance or plumbing fixture. In preferred example embodiments the top surface 22 of the mat 20 diverts any water that contacts the surface towards one or more water collection cups 30 (see FIG. 6). Additionally, the top surface 22 can also include a water dam or lip 24 that lines the circumference of the mat 20 for retaining all water that collects on the mat. The water collection cups 30 are depicted in the drawing figures as circular in shape; however, the cups can be any desired shape. The depth of the water collection cups 30 can vary depending on the level of sensitivity desired of the apparatus by the user.

The leak detector apparatus 10 also includes at least one pair of continuous spaced wires 40 for sensing the presence of water. The wires 40 can be horizontally and/or vertically spaced apart depending on the application and desired sensitivity. In example embodiments, the wires 40 traverse the length and/or the circumference of the mat 20 and preferably extend through the collection cups 30. In other embodiments, the sensor wires 40 extend within or beneath one or more layers of the mat 20. It is preferable, but not required, that each wire 40 is non-insulated and coated with conduction materials that resist corrosion and oxidation for the life of the apparatus 10. Water (not shown) that bridges the sensor wires 40 creates an electrical contact, wherein the electrical resistance between the sensor wires is lowered significantly. By lowering the electrical resistance between the two wires 40 an electronics module 50 associated with the wires can detect the presence of water within the apparatus 10. The sensitivity of the apparatus 10 can be regulated by controlling the depth of the water collection cups 30 and/or by regulating the depth the sensor wires 40 extend through the cups. For example, by extending the wires 40 through a collector cup 30 near the bottom of the cup, less water is needed before the gap between the wires is bridged. Conversely, by providing a deeper cup and/or positioning the wires near the top of the cup requires a greater amount of water to bridge the wires.

The electronics module 50 can be fixed to the mat 20 of the leak detector apparatus 10 (as seen in FIG. 1) or it can be connected to the mat with a connector wire 52 (as seen in FIG. 2). In such embodiments wherein the module 50 is mounted remotely from the mat 20, the module may be secured to an adjacent appliance, fixture, or rest freely on a surrounding surface. The module 50 can contain a microprocessor that interfaces with the sensor wires 40. If the microprocessor determines that water is present, it can alert a user that water was found in numerous ways including: a local indicator light, an audible sound, notify a master controller, etc. In further embodiments, the module 50 can be electronically coupled with a master controller, whereby the master controller monitors the leak status of several leak detector apparatuses. The module 50 can be associated with a master controller through the use of hard wiring, radio frequency (RF), infrared technology (IR), or other non-contact manners. Power can be provided to the module 50 via a battery, or the module can be plugged into the home/office electrical system if available.

Referring now to specific example embodiments, FIG. 2 depicts a leak detector apparatus that only includes one row of collector cups 30. While FIG. 2 only depicts three collector cups 30, it is understood that other embodiments may utilize more or fewer such cups in one or more rows. In this embodiment, the electronics module 50 is not directly affixed to the surface of the mat 20, but is rather connected to the sensor wires 40 with a connector wire 52. As such, the placement of the electronics module 50 is variable and can be affixed to an appliance or other fixture as seen in FIG. 3. It is preferable that the collector cups 30 collect water that drips or leaks from the appliance/plumbing fixture and falls on top of the apparatus 10. In order to detect the presence of water on the floor or surrounding supporting structure, the leak detector apparatus 10 of this embodiment and others can also include one or more pairs of sensing wires 40 present on the bottom 24 of the mat 20 as seen in FIG. 4. Due to its narrow width, this particular example embodiment easily can be placed into tight locations or can be used in conjunction with existing appliances. Additionally, this embodiment, along with all other embodiments described herein, can optionally include feet 15 formed in the lowermost layer of the mat 20 to support the mat above the floor to minimize the growth of mold, algae, mildew, and fungus.

FIG. 5 depicts an example embodiment of a leak detector apparatus 110 that is designed for use in conjunction with a toilet. It can be seen from the drawing figure that the mat 120 has a cutout 160, forming a V-shape, to receive the bottom of the toilet therein. In this manner, the mat 120 can be placed on the floor and surround the sides and rear of the toilet to detect water leakage. It can be seen that water contacting the top surface 122 of the mat 120 can be funneled towards the collector cups 130 via dimples 126 that surround the cups 130. This embodiment can also utilize sensing wires 140 along the bottom of the mat 120 to detect the presence of water along the floor. In this embodiment the electronics module 150 is shown affixed to the mat 120; however, this configuration is not required.

FIG. 6 is an example embodiment of leak detector apparatus 210 to be used in conjunction with a refrigerator. The apparatus 210 of this embodiment is an elongated mat 220 having multiple collector cups 230 placed along a central channel of the mat. Preferably, the mat 220 has dividers 232 and funnels 234 between the cups 230 for funneling water that contacts the top surface of the mat into the cups. Sensing wires 240 can also be positioned on the underside of the mat 220. It is intended that the mat 220 of the present embodiment be positioned along the length of the refrigerator body, wherein at least a portion of the mat rests beneath the refrigerator. As such, it may be advantageous for the mat 220 to have slots 262 cut out of the ends, as seen in FIG. 4, to enable a user to maneuver the mat beneath the refrigerator while avoiding the refrigerator's support feet. Example mat 220 lengths can range from about 18 inches long to about 40 inches long or as required for a particular refrigerator. In this embodiment the module 250 can utilize a magnetic case to enable a user to affix the module anywhere on the refrigerator.

FIGS. 7 depicts an example embodiment of a leak detector apparatus 310 to be used in conjunction with a variety of appliances such as a washing machine, stand-alone icemaker, dishwasher, etc. In this particular embodiment, the mat 320 is preferably rectangular shaped and sized to accommodate the footprint of the appliance that the mat is intended to be used in conjunction with. The mat 320 of the present embodiment can have cutouts 364 for the support feet of the appliance if necessary. It should also be noted that dividers 332 or funnels 334 (as seen in FIG. 6) can be used to channel water into the collector cups 330 if desired. Example mat sizes range from about 18 inches wide to about 24 inches wide and are typically about 24 inches deep. Other mat sizes can easily be produced to accommodate unusually large or small appliances. As with all embodiments of the present invention, sensor wires 340 can be provided on the top and bottom surfaces of the mat 320 as desired.

FIG. 8 shows an example embodiment of a leak detector apparatus 410 to be used in conjunction with a sink and/or a sink vanity. Generally, the mat 420 in this embodiment can be rectangular and/or can mimic the footprint of the sink or vanity. In this regard, collector cups 430 can be placed along the perimeter of the mat 420, wherein the cups are connected by one or more channels 436 as seen in the drawing figure. In one particular example embodiment the mat can be roughly 15 inches by 17 inches in size, but can be manufactured in a variety of other sizes to meet the particular application.

It is conceivable that a single home or office may utilize multiple leak detector apparatuses of the present invention to detect possible water leaks around several appliances, plumbing fixtures etc. Therefore, each apparatus may be coupled to a master controller 70 to form a leak detection system. Such a system can permit a user to review one master controller 70 device for the status of all such apparatuses as seen in FIG. 9. Additionally, the master controller 70 can be wired into the resident/office phone line and equipped with an auto dialer for alerting a user by phone of a possible leak. As noted earlier, each electronics module (50) can be associated with a master controller 70 through the use of hard wiring, radio frequency (RF), infrared technology (IR), or other non-contact manners. For instance, each module (50) can also serve as a RF box having an internal or external antenna 54 to communicate with the master controller 70 as depicted in FIG. 10. As seen in FIG. 11 the master controller 70 can include an internal or external antenna 72, one or more display screens 74, control buttons 76, and an outlet plug 78. The master controller can alert a user to an abundance of information such as, but not limited to, the leak status of all of the leak detector apparatuses, battery condition of the remote units, and leak history of all of the linked up units.

While the invention has been described with reference to preferred and example embodiments, it will be understood by those skilled in the art that a variety of modifications, additions and deletions are within the scope of the invention, as defined by the following claims.

What is claimed is:

1. A leak detector apparatus for use on a floor and in conjunction with an appliance, plumbing fixture or other potential water leak source, the leak detector apparatus comprising:
a non-conducting mat shaped and dimensioned to rest atop the floor and to be positioned under, beside, or around the appliance, plumbing fixture or other potential water leak source, the mat comprising one or more layers and having a plurality of water collector cups therein;
a pair of spaced apart sensor wires extending within or beneath one of the one or more layers of the mat and extending through the water collector cups, the sensor wires being operative to sense the presence of water in the cups; and
an electronics module associated with the sensor wires and electrically coupled thereto for triggering an alert in response to the presence of water in one or more of the cups.

2. A leak detector apparatus as claimed in claim 1 wherein the mat is shaped to generally match a footprint of the appliance, plumbing fixture or other potential water leak source.

3. A leak detector apparatus as claimed in claim 1 wherein the pair of spaced apart sensor wires extends generally around the periphery of the mat.

4. A leak detector apparatus as claimed in claim 3 further comprising a second pair of spaced apart sensor wires, with one pair of the sensor wires provided for detecting water falling onto the leak detector apparatus and the other pair of sensor wires provided for detecting water seeping under the mat.

5. A leak detector apparatus as claimed in claim 1 wherein the electronics module is electrically coupled to a master controller.

6. A leak detector apparatus as claimed in claim 5 wherein the electronics module is coupled to a master controller via RF, IR or some other non-contact manner.

7. A leak detector apparatus as claimed in claim 1 wherein the electronics module is positioned on the mat.

8. A leak detector apparatus as claimed in claim 1 wherein the electronics module is positioned off the mat.

9. A leak detector apparatus as claimed in claim 1 wherein the mat comprises an elongated, narrow mat for use with a refrigerator.

10. A leak detector apparatus as claimed in claim 1 wherein the mat comprises a generally U-shaped mat for use with a toilet.

11. A leak detector apparatus as claimed in claim 1 wherein the mat comprises a generally rectangular mat having spaced apart cut-outs and being adapted for use with a dishwasher, ice maker, or washing machine, the cut-outs accommodating feet of the dishwasher, ice maker or washing machine therein.

12. A leak detector apparatus as claimed in claim 1 wherein the mat includes shallow funnels for collecting water and funneling it into the cups.

13. A leak detector apparatus as claimed in claim 1 wherein the mat is flexible to allow it to be conformed to various shapes.

14. A leak detector apparatus as claimed in claim 1 wherein the spaced-apart sensor wires are spaced apart horizontally.

15. A leak detector apparatus as claimed in claim 1 wherein the spaced-apart sensor wires are spaced apart vertically.

16. A leak detector apparatus as claimed in claim 15 wherein the one or more layers of the non-conducting mat comprise at least two layers, with at least one layer positioned between the spaced-apart sensor wires.

17. A leak detector apparatus as claimed in claim 1 wherein the sensor wires are un-insulated prior to installation between the multiple layers of the mat.

18. A leak detector apparatus as claimed in claim 1 wherein the mat has dimples formed in the lowermost layer thereof to deepen the water collector cups.

19. A leak detector apparatus as claimed in claim 1 wherein the mat has feet formed in the lowermost layer thereof to support most of the mat above the floor to minimize the growth of mold, algae, mildew, and fungus.

20. A leak detector apparatus for use on a floor and in conjunction with an appliance, plumbing fixture or other potential water leak source, the leak detector apparatus comprising:
a non-conducting mat shaped and dimensioned to rest atop the floor and to be positioned under, beside, or around the appliance, plumbing fixture or other potential water leak source;
a pair of spaced apart sensor wires extending within or beneath the mat and extending generally along at least one peripheral edge thereof, the sensor wires being operative to sense the presence of water along a peripheral edge of the appliance, plumbing fixture or other potential water leak source; and
an electronics module associated with the sensor wires and electrically coupled thereto for triggering an alert in response to the presence of water.

21. A leak detector apparatus as claimed in claim 20 wherein the mat is shaped to generally match a footprint of the appliance, plumbing fixture or other potential water leak source.

22. A leak detector apparatus as claimed in claim 20 further comprising a second pair of spaced apart sensor wires, with one pair of the sensor wires provided for detecting water falling onto the leak detector apparatus and the other pair of sensor wires provided for detecting water seeping under the mat.

23. A leak detector apparatus as claimed in claim 20 wherein the mat comprises an elongated, narrow mat for use with a refrigerator.

24. A leak detector apparatus as claimed in claim 20 wherein the mat comprises a generally U-shaped mat for use with a toilet.

25. A leak detector apparatus as claimed in claim 20 wherein the mat comprises a generally rectangular mat having spaced apart cut-outs and being adapted for use with a dishwasher, ice maker, or washing machine, the cut-outs accommodating feet of the dishwasher, ice maker or washing machine therein.

26. A leak detection system for use on a floor and in conjunction with two or more appliances, plumbing fixtures or other potential water leak sources, the leak detector system comprising:
a plurality of leak detection mats adapted to be placed on the floor positioned under, beside, or around an appliance, plumbing fixture or other potential water leak source, each leak detection mat including one or more sensors for detecting the presence of liquid;
a plurality of local processors electrically coupled to the plurality of sensors, the local processors being provided at least one per leak detection mat; and
a master controller in communication with the local processors for monitoring the function and operation of each local processor.

27. A leak detection system as claimed in claim 26 wherein the master controller is operative to determine which, if any, of the leak detection mats has detected a leak.

28. A leak detection system as claimed in claim 26 wherein the local processors are coupled to the master controller via RF, IR or some other non-contact manner.
